(19) United States
(12) Patent Application Publication
(10) Pub. No.: US 2016/0084661 A1
(43) Pub. Date: Mar. 24, 2016

(54) PERFORMANCE DRIVING SYSTEM AND METHOD

(71) Applicant: GM GLOBAL TECHNOLOGY OPERATIONS LLC, Detroit, MI (US)

(72) Inventors: Neeraj R. Gautama, Whitby (CA); Jarvis Chau, Markham (CA); Roddi L. Macinnes, Thornhill (CA); Akkas A. Mughal, Port Elgin (CA); Joshua Lo, Whitby (CA)

(21) Appl. No.: 14/493,519

(22) Filed: Sep. 23, 2014

(51) Int. Cl. G01C 21/26; G06T 11/60

(52) U.S. Cl. CPC G01C 21/26; G06T 11/60

(57) ABSTRACT

A system and method that act as a performance driving tool and provide feedback to a driver, such as real-time visual feedback delivered via an augmented reality device. According to one embodiment, the performance driving system gathers pertinent vehicle information and driver information (e.g., the direction of the driver's gaze as determined by a wearable head-mounted-display (HMD)) and uses these inputs to generate real-time visual feedback in the form of virtual driving lines and other driving recommendations. These driving recommendations can be presented to the driver via an augmented reality device, such as a heads-up-display (HUD), where the virtual driving lines are projected onto the vehicle windshield so that they are superimposed on top of the actual road surface seen by the driver and can show the driver a suggested line or path to take. Other driving recommendations, like braking, acceleration, steering and shifting suggestions, can also be made.

### FIELD

The present invention generally relates to performance driving tools and, more particularly, to performance driving systems and methods that provide a driver with on-track feedback in the form of driving recommendations in order to enhance the driving experience.

### BACKGROUND

There is a desire among many drivers of track or performance vehicles to improve their driving skills, and one way to accomplish this is through the use of performance driving tools that gather and process data when the vehicle is being driven. The precise nature of the input and output of such performance driving tools can vary widely, depending on factors such as the vehicle type, the skill level of the driver, the track or course being driven, etc., but typically such tools are employed in professional or semi-professional racing applications and are not easily translatable to production vehicles, even track or high performances production vehicles.

### SUMMARY

According to one embodiment, there is provided a performance driving system for a vehicle. The system may comprise: one or more vehicle sensor(s), the vehicle sensor(s) include a navigation unit that provides navigation signals representative of vehicle location; one or more output device(s), the output device(s) include an augmented reality device that provides real-time visual feedback to a driver; and a control module coupled to the vehicle sensor(s) and the output device(s). The control module is configured to provide control signals to the augmented reality device that are at least partially based on the vehicle location and that cause the augmented reality device to provide the driver with real-time visual feedback that includes one or more virtual driving line(s) superimposed on top of an actual road surface seen by the driver.

According to another embodiment, there is provided a performance driving system for a vehicle. The system may comprise: one or more driver sensor(s), the driver sensor(s) include a camera that is directed towards the face of the driver and provides driver signals representative of the facial behavior of the driver; one or more output device(s), the output device(s) provide on-track driving recommendations to a driver; and a control module coupled to the driver sensor(s) and the output device(s). The control module is configured to provide control signals to the output device(s) that cause the output device(s) to make adjustments to the on-track driving recommendations based at least partially on changes in the facial behavior of the driver.

According to another embodiment, there is provided a method for operating a performance driving system for a vehicle. The method may comprise the steps of: receiving signals from one or more vehicle sensor(s) at a control module while the vehicle is being driven, the vehicle sensor signals relate to the operational state of the vehicle; receiving signals from one or more driver sensor(s) at the control module while the vehicle is being driven, the driver sensor signals relate to the facial behavior of the driver; providing the driver with one or more driving recommendation(s) while the vehicle is being driven, wherein the driving recommendation(s) is at least partially based on the vehicle sensor signals; and adjusting the driving recommendation(s) while the vehicle is being driven, wherein the adjustment to the driving recommendation(s) is at least partially based on the facial behavior of the driver.

### DRAWINGS

Preferred exemplary embodiments will hereinafter be described in conjunction with the appended drawings, wherein like designations denote like elements, and wherein:

FIG. 1 is a schematic view of a vehicle having an exemplary performance driving system in accordance with one embodiment;

FIG. 2 is a flowchart illustrating an exemplary method for use with a performance driving system, such as the system shown in FIG. 1;

FIG. 3 shows an exemplary heads-up-display (HUD) and instrument panel display that may be used with a performance driving system, such as the one in FIG. 1; and

FIG. 4 shows an exemplary head-mounted-display (HMD) and instrument panel display that may be used with a performance driving system, such as the one in FIG. 1.

### DESCRIPTION

The performance driving system and method described herein may be used to gather information during performance driving events and to provide feedback to a driver so as to enhance the driving experience, such as real-time or on-track visual feedback delivered via an augmented reality device. “Augmented reality device,” as used herein, broadly refers to any device that delivers, presents and/or otherwise provides a user with output on the mixed reality spectrum between actual reality and total virtual reality, including but not limited to output that includes augmented reality scenarios and augmented virtuality scenarios. According to one embodiment, the performance driving system gathers pertinent vehicle information (e.g., vehicle location, speed and gear information) as well as driver information (e.g., the direction of the driver's gaze as determined by a wearable head-mounted-display (HMD) or an in-vehicle vision system) and uses this input to generate on-track visual feedback or other output in the form of virtual driving lines and other driving recommendations. This output can be presented to the driver via an augmented reality device, such as a heads-up-display (HUD), where the virtual driving lines are projected onto the vehicle windshield or a combiner screen so that they are overlaid or superimposed on top of the actual road surface seen by the driver and can show the driver a suggested line or path to take. Other driving recommendations, like braking and acceleration suggestions, can also be displayed on the windshield via the HUD or can be conveyed to the driver using other visual, audible and/or haptic alerts. The performance driving system can also gather and save relevant driving information with a data storage device (e.g., a cloud-based database) so that it can be further analyzed and reviewed at a later time. As used herein, a “track vehicle” broadly refers to any high performance production or non-production vehicle, like a racing inspired sports car, where a performance driving tool would be appropriate.

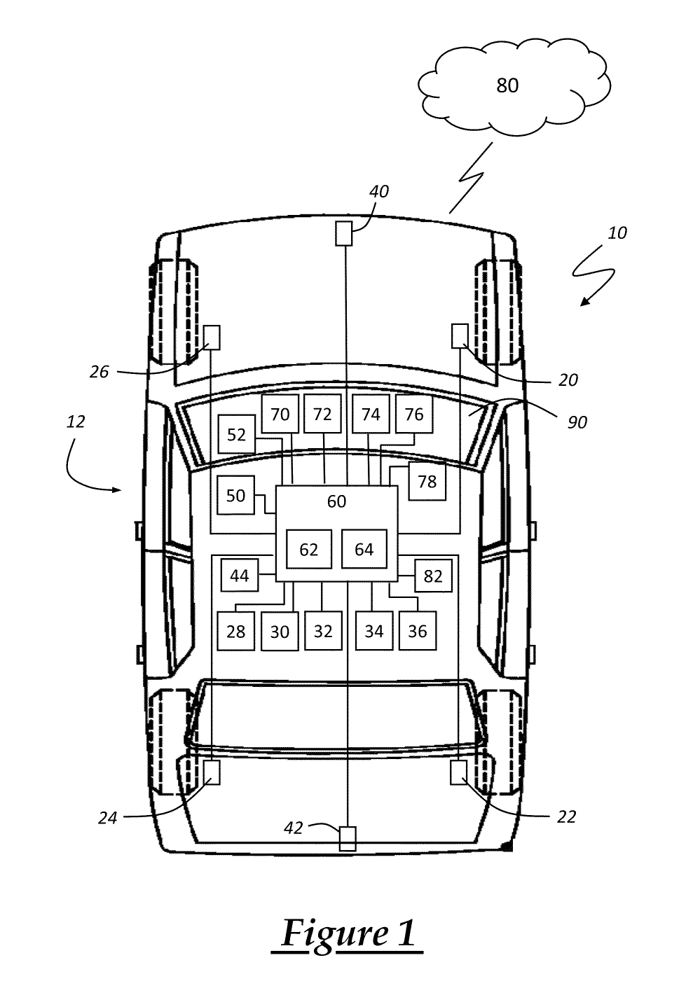

With reference to FIG. 1, there is shown a schematic representation of an exemplary vehicle that may be equipped with the performance driving system described herein. It should be appreciated that the performance driving system and method may be used with any type of track vehicle, including professional race cars, production sports cars, passenger vehicles, sports utility vehicles (SUVs), cross-over vehicles, hybrid electric vehicles (HEVs), battery electrical vehicles (BEVs), high performance trucks, motorcycles, etc. These are merely some of the possible applications, as the performance driving system and method described herein are not limited to the exemplary embodiment shown in FIG. 1 and could be implemented with any number of different vehicles. According to one embodiment, vehicle 10 is a track vehicle in the form of a production sports car (e.g., a Corvette™, a Camaro Z28™, a Cadillac CTS-V™, etc.) that is designed for performance driving and includes a performance driving system 12 with vehicle sensors 20-36, exterior sensors 40-44, driver sensors 50-52, a control module 60, and output devices 70-82.

Any number of different sensors, components, devices, modules, systems, etc. may provide the performance driving system 12 with information, data and/or other input. These include, for example, the exemplary components shown in FIG. 1, as well as others that are known in the art but are not shown here such as accelerator pedal sensors and brake pedal sensors. It should be appreciated that the vehicle sensors 20-36, exterior sensors 40-44, driver sensors 50-52, control module 60, and output devices 70-82, as well as any other component that is a part of and/or is used by the performance driving system 12 may be embodied in hardware, software, firmware or some combination thereof. These components may directly sense or measure the conditions for which they are provided, or they may indirectly evaluate such conditions based on information provided by other sensors, components, devices, modules, systems, etc. Furthermore, these components may be directly coupled to control module 60, indirectly coupled via other electronic devices, a vehicle communications bus, network, etc., or coupled according to some other arrangement known in the art. These components may be integrated within another vehicle component, device, module, system, etc. (e.g., sensors that are already a part of an engine control module (ECM), traction control system (TCS), electronic stability control (ESC) system, antilock brake system (ABS), etc.), they may be stand-alone components (as schematically shown in FIG. 1), or they may be provided according to some other arrangement. It is possible for any of the various sensor signals or readings described below to be provided by some other component, device, module, system, etc. in vehicle 10 instead of being directly provided by an actual sensor element. In some instances, multiple sensors might be employed to sense a single parameter (e.g., for providing redundancy). It should be appreciated that the foregoing scenarios represent only some of the possibilities, as any type of suitable sensor arrangement may be used to obtain information for the performance driving system 12. That system is not limited to any particular sensor or sensor arrangement.

Vehicle sensors 20-36 may provide the performance driving system 12 with various pieces of information and data relating to the vehicle 12 which, as mentioned above, is preferably a track vehicle. According to the non-limiting example shown in FIG. 1, the vehicle sensors may include speed sensors 20-26, a vehicle dynamics sensor unit 28, a navigation unit 30, an engine control module 32, a brake control module 34, and a steering control module 36. The speed sensors 20-26 provide the system 12 with speed signals or readings that are indicative of the rotational speed of the wheels, and hence the overall speed or velocity of the vehicle. In one embodiment, individual wheel speed sensors 20-26 are coupled to each of the vehicle's four wheels and separately provide speed signals indicating the rotational velocity of the corresponding wheel. Skilled artisans will appreciate that these sensors may operate according to optical, electromagnetic or other technologies, and that speed sensors 20-26 are not limited to any particular speed sensor type. In another embodiment, the speed sensors could be coupled to certain parts of the vehicle, such as an output shaft of the transmission or behind the speedometer, and produce speed signals from these measurements. It is also possible to derive or calculate speed signals from acceleration signals (skilled artisans appreciate the relationship between velocity and acceleration readings). In another embodiment, speed sensors 20-26 determine vehicle speed relative to the ground by directing radar, laser and/or other signals towards the ground and analyzing the reflected signals, or by employing feedback from a navigation unit that has Global Positioning System (GPS) capabilities. It is possible for the speed signals to be provided to the performance driving system 12 by some other module, subsystem, system, etc., like an engine control module 32 or a brake control module 34. Any other suitable known speed sensing techniques may be used instead.

Vehicle dynamics sensor unit 28 provides the system 12 with vehicle dynamics signals or readings that are indicative of various dynamic conditions occurring within the vehicle, such as the lateral acceleration and yaw rate of the vehicle 10. Unit 28 may include any combination of sensors or sensing elements that detect or measure vehicle dynamics, and may be packaged separately or in a single unit. According to one exemplary embodiment, vehicle dynamics sensor unit 28 is an integrated inertial measurement unit (IMU) that includes a yaw rate sensor, a lateral acceleration sensor, and a longitudinal acceleration sensor. Some examples of suitable acceleration sensor types include micro-electromechanical system (MEMS) type sensors and tuning fork-type sensors, although any type of acceleration sensor may be used. Depending on the particular needs of the system, the acceleration sensors may be single- or multi-axis sensors, may detect acceleration and/or deceleration, may detect the magnitude and/or the direction of the acceleration as a vector quantity, may sense or measure acceleration directly, may calculate or deduce acceleration from other readings like vehicle speed readings, and/or may provide the g-force acceleration, to cite a few possibilities. Although vehicle dynamics sensor unit 28 is shown as a separate unit, it is possible for sensor unit 28 to be integrated into some unit, device, module, system, etc.

Navigation unit 30 provides the performance driving system 12 with navigation signals that represent the location or position of the vehicle 10. Depending on the particular embodiment, navigation unit 30 may be a stand-alone component or it may be integrated within some other component or system within the vehicle. The navigation unit may include any combination of other components, devices, modules, etc., like a GPS unit, and may use the current position of the vehicle and road- or map-data to evaluate the upcoming road. For instance, the navigation signals or readings from unit 30 may include the current location of the vehicle and information regarding the configuration of the upcoming road segment (e.g., upcoming turns, curves, forks, embankments, straightaways, etc.), and can be provided so that the performance driving system 10 can compare the recommended and predicted driving lines taken by the driver, as will be explained. It is also possible for navigation unit 30 to have some type of user interface so that information can be verbally, visually or otherwise exchanged between the unit and the driver. The navigation unit 30 can store pre-loaded map data and the like, or it can wirelessly receive such information through a telematics unit or some other communications device, to cite two possibilities.

Engine control module 32, brake control module 34, and steering control module 36 are examples of different vehicle control modules that include various sensor combinations and may provide the performance driving system 10 with engine, brake, and steering status signals or readings that are representative of the states of those different vehicle systems. For instance, the engine control module 32 could provide system 10 with a variety of different signals, including engine status signals indicating a speed of the engine, a transmission gear selection, an accelerator pedal position and/or any other piece of information or data that is pertinent to operation of the engine. This applies to both internal combustion engines, as well as electric motors in the case of hybrid vehicles. The brake control module 34 may similarly provide the performance driving system 10 with brake status signals that indicate the current state or status of the vehicle brake system, including such items as a brake pedal position, an antilock braking status, a wheel slip or stability reading, etc. The brake status signals may pertain to traditional frictional braking systems, as well as regenerative braking systems used in hybrid vehicles. The steering control module 36 sends steering status signals to the performance driving system 10, where the steering status signals may represent a steering angle or position, steering wheel movement or direction, a driving mode selection (e.g., a sport mode with tighter steering), readings taken out at the corners of the vehicle, readings taken from a steering wheel, shaft, pinion gear or some other steering system component, or readings provided by some other vehicle system like a steer-by-wire system or an anti-lock brake system (ABS). The aforementioned control modules may include any combination of electronic processing devices, memory devices, input/output (I/O) devices, and other known components, and they may be electronically connected to other vehicle devices and modules via a suitable vehicle communications network, and can interact with them when required. It should be appreciated that engine control modules, brake control modules and steering control modules are well known in the art and are, therefore, not described here in detail.

Accordingly, the vehicle sensors 20-36 may include any combination of different sensors, components, devices, modules, systems, etc. that provide the performance driving system 12 with information regarding the status, state and/or operation of the vehicle 10. For instance, one of the vehicle sensors 20-36 may provide the system 12 with a vehicle identification number (VIN) or some other type of vehicle identifier or information; the VIN can be used to determine the vehicle's weight, platform-style, horsepower, transmission specifications, suspension specifications, engine information, body type, model, model year, etc. Other types of vehicle information may certainly be provided as well, including tire pressure, tire size, lift kit information or information regarding other suspension alterations, brake modifications such as high temperature capacity brake components or carbon racing pads for example, voltage and current readings for hybrid vehicles, slip-differential data, temperature, or outputs of vehicle diagnostic algorithms. It may also be possible for the driver or a system user to manually input or provide vehicle information.

Turning now to exterior sensors 40-44, the vehicle 10 may be equipped with any number of different sensors or other components for sensing and evaluating surrounding objects and conditions exterior to the vehicle, such as nearby target vehicles, stationary roadside objects like guardrails, weather conditions, etc. According to the exemplary embodiment shown in FIG. 1, the performance driving system 12 includes a forward target sensor 40 and a rearward target sensor 42, but it could include additional sensors for monitoring areas on the side of the vehicle 10 as well. Target vehicle sensors 40 and 42 may generate target vehicle signals and/or other data that is representative of the size, nature, position, velocity and/or acceleration of one or more nearby objects, like target vehicles in adjacent lanes. These readings may be absolute in nature (e.g., a target vehicle velocity reading (v_{TAR}) or a target vehicle acceleration reading (a_{TAR}) that is relative to ground) or they may be relative in nature (e.g., a relative velocity reading (Δv) which is the difference between the target vehicle velocity and that of the host vehicle, or a relative acceleration reading (Δa) which is the difference between target and host vehicle accelerations). It is also possible for the target vehicle sensors 40 and 42 to identify and evaluate potholes, debris in the road, etc. so that the system 12 can take such input into account before making one or more driving recommendations. Target vehicle sensors 40 and 42 may be a single sensor or a combination of sensors, and may include a light detection and ranging (LIDAR) device, radio detection and ranging (RADAR) device, vision device (e.g., camera, etc.), a vehicle-to-vehicle communication device, some other known sensor type, or a combination thereof. According to one embodiment, a camera is used in conjunction with the forward and/or rearward target vehicle sensors 40 and 42, as is known in the art.

Environmental sensor 44 includes one or more sensors and provides the performance driving system 12 with environmental signals or readings regarding outside weather or other environmental conditions that could affect driving. For example, environmental sensor 44 may report an outside temperature, an outside humidity, current or recent data on precipitation, road conditions, or any other type of environmental readings that may be relevant to a performance driving event. By knowing the outside temperature and the amount of recent precipitation, for instance, the performance driving system 12 may adjust the driving recommendations that it makes to the driver in order to take into account slippery road surfaces and the like. The sensor 44 may determine environmental conditions by directly sensing and measuring such conditions, indirectly determining environmental readings by gathering them from other modules or systems in the vehicle, or by receiving wireless transmissions that include weather reports, forecasts, etc. from a weather-related service or website. In the last example, the wireless transmissions may be received at the telematics unit 82 which then conveys the environmental signals to the control module 60.

Thus, the exterior sensors 40-44 may include any combination of different sensors, cameras, components, devices, modules, systems, etc. that provide the performance driving system 12 with information regarding the presence, status, state, operation, etc. of exterior objects or conditions. For example, the exterior sensors could employ some type of vehicle-to-vehicle or vehicle-to-facility communications features in order to determine the presence and location of surrounding vehicles, to cite one possibility.

Driver sensors 50-52 may be used to provide the performance driving system 12 with driver sensor signals that include information and data relating to the behavior, actions, intentions, etc. of the driver. Unlike most other driving systems, the performance driving system 12 can use a combination of vehicle and exterior sensor readings, as well as driver sensor readings, when evaluating a performance driving scenario and making recommendations to the driver. Driver sensors 50-52 are designed to monitor and evaluate certain driver actions or behavior, for example facial behavior, in order to provide the system 12 with a richer or fuller set of inputs that go beyond simply providing vehicle dynamic information. In one non-limiting example, driver sensor 50 includes a camera that is trained on the driver's face to observe and report certain driver behavior, like the direction of where the driver is looking and/or duration of their gaze or stare; so-called “gaze detection.” Camera 50 can collect information relating to the driver, including but not limited to facial recognition data, eye tracking data, and gaze detection data, and may do so using video, still images or a combination thereof. Camera 50 may also obtain images that represent the driver's viewing perspective. In a particular embodiment, the camera is an infrared camera, but the camera could instead be a conventional visible light camera with sensing capabilities in the infrared wavelengths, to cite several possibilities.

In accordance with one embodiment, the driver sensor 50 is integrated into or is otherwise a part of a wearable device, such as a head-mounted-display (HMD) like Google Glass™ or some other augmented reality device that is being worn by the driver. Wearable devices or technology such as this can provide the performance driving system 12 with input regarding the facial expressions, facial orientations, mannerisms, or other human input. The driver sensor 50 may include the wearable device itself, a wired or wireless port that is integrated with system 12 and receives signals from the wearable device, or both. By utilizing existing technology that is already part of the wearable device and receiving signals or readings from such a device, the performance driving system 12 can be implemented into the vehicle 10 with minimal cost when compared to systems that have one or more dedicated cameras built into the vehicle and focused on the driver. Moreover, the driver signals from driver sensor 50 may be provided to and used by other systems in the vehicle 10, such as vehicle safety systems. Of course, driver sensor 50 may be a stand alone device in communication with control module 60, as illustrated, or it may be a part of another vehicle system such as an active safety system. The driver sensor 50 may include additional components such as a gyroscope or other features that improve the imaging quality, as will be apparent to one having ordinary skill in the art. The driver sensor 50 can then provide the system 12 with driver signals that can be taken into account by the system when providing one or more virtual driving lines and other driving recommendations, as will be explained.

Driver sensor 52 can include other behavioral sensors, such as those that determine driver hand positions on the steering wheel, the posture of the driver, and/or other behavioral indicia that may be useful when making recommendations in a performance driving scenario. Like the previous sensors, driver sensor 52 can convey this information to the performance driving system 12 in the form of driver signals or readings. Again, the performance driving system 12 is not limited to any particular type of driver sensor or camera, as other sensors and techniques may be employed for monitoring, evaluating and reporting driver behavior.

Control module 60 is coupled to vehicle sensors 20-36, exterior sensors 40-44, driver sensors 50-52, output devices 70-82 and/or any other components, devices, modules, systems, etc. on the vehicle 10. Generally speaking, the control module 60 is designed to receive signals and readings from the various input devices (20-36, 40-44, 50-52), process that information according to algorithms that are part of the present method, and provide corresponding driving recommendations and other information to the driver via output devices 70-82. Control module 60 may include any variety of electronic processing devices, memory devices, input/output (I/O) devices, and/or other known components, and may perform various control and/or communication related functions. In an exemplary embodiment, control module 60 includes an electronic memory device 62 that stores sensor readings (e.g., sensor readings from sensors 20-36, 40-44, 50-52), look up tables or other data structures, algorithms, etc. Memory device 62 may also store pertinent characteristics and background information pertaining to vehicle 10, such as information relating to prior races, gear transitions, acceleration limits, temperature limits, driving habits or other driver behavioral data, etc. Control module 60 also includes an electronic processing device 64 (e.g., a microprocessor, a microcontroller, an application specific integrated circuit (ASIC), etc.) that executes instructions for software, firmware, programs, algorithms, scripts, etc. that are stored in memory device 62 and may partially govern the processes and methods described herein. Control module 60 may be electronically connected to other vehicle devices, modules and systems via suitable vehicle communications and can interact with them when required. These are, of course, only some of the possible arrangements, functions and capabilities of control module 60, as other embodiments could also be used.

Depending on the particular embodiment, the control module 60 may be a stand-alone vehicle electronic module (e.g., a sensor controller, an object detection controller, a safety controller, etc.), may be incorporated or included within another vehicle electronic module (e.g., an automated driving control module, an active safety control module, a brake control module, a steering control module, an engine control module, etc.), or may be part of a larger network or system (e.g., an automated driving system, an adaptive cruise control system, a lane departure warning system, an active safety system, a traction control system (TCS), an electronic stability control (ESC) system, an antilock brake system (ABS), etc.), to name a few possibilities. In a different embodiment, the control module 60 may be incorporated within the augmented reality device 70 (e.g., within the head-mounted display (HMD) unit), and may wirelessly send and/or receive signals to and/or from various vehicle based sensors or modules. Accordingly, the control module 60 is not limited to any one particular embodiment or arrangement and may be used by the present method to control or supplement one or more aspects of the vehicle's operation.

Output devices 70-82 may be used to provide the driver with on-track or real-time visual and other feedback during a performance driving scenario, such as recommended or ideal driving lines and other driving recommendations. According to one embodiment, the output devices may include an augmented reality device 70, a visual display unit 72, an audible alert unit 74, a haptic alert unit 76, an on-board data recording unit 78, a remote data recording unit 80, and/or a telematics unit 82. It should be appreciated that the term “real-time feedback” does not necessarily mean instantaneous feedback, as it takes a certain amount of time to gather inputs, process them, and generate corresponding outputs. Thus, “real-time feedback,” as used herein, broadly means any control or command signal, output and/or other type of feedback that is provided contemporaneously with the driving event so that the feedback can be considered by the driver while he or she is driving. Of course, this particular combination of output devices is simply one possibility, as the performance driving system 12 may employ different combinations of output devices, including devices and systems not shown here.

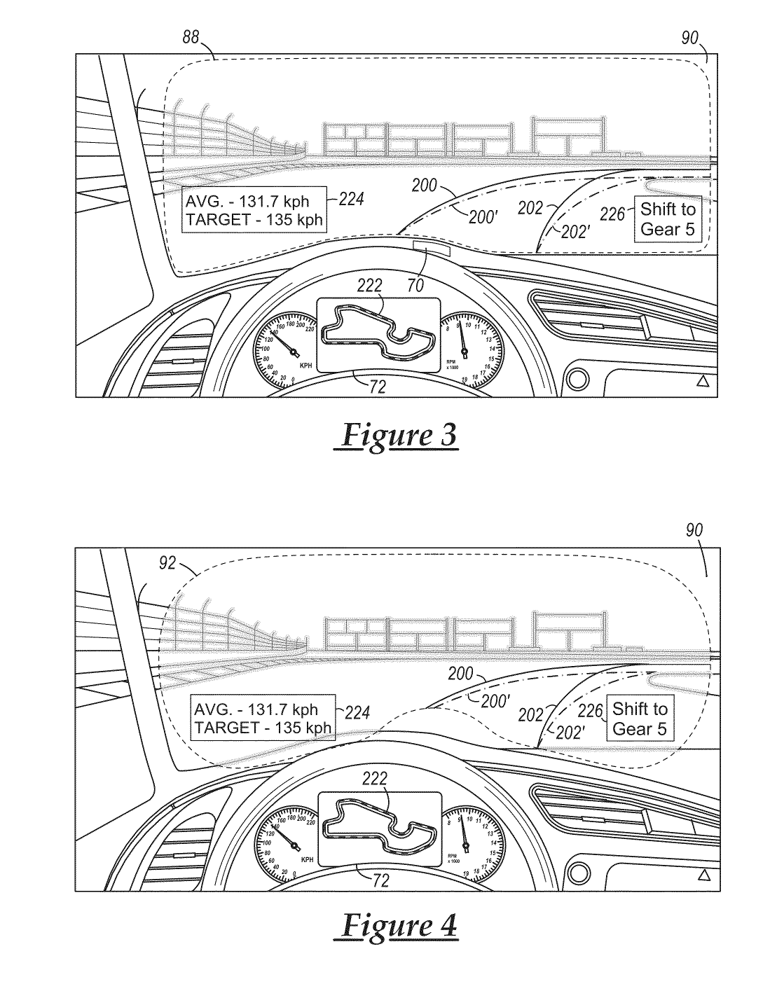

Augmented reality device 70 is used by the system to present the driver with on-track or real-time visual feedback regarding driving performance so as to enhance the driving experience. The augmented reality device 70 may include a heads-up-display (HUD) unit that presents the driver with driving recommendations by projecting graphics and other information onto the windshield of the vehicle at a location that is easy for the driver to see, as illustrated in FIG. 3, or it may include a head-mounted-display (HMD) that the driver wears while driving, as shown in FIG. 4. The augmented reality device 70, whether it be a HUD or a HMD, generally presents information in real-time with environmental elements, such as by projecting recommended driving lines onto the windshield so that they appear to be superimposed on the road surface that the driver sees. Other driving recommendations, like braking and acceleration suggestions, can also be displayed on the windshield via the HUD or can be conveyed to the driver using other visual, audible and/or haptic alerts. According to one embodiment, the control module 60 provides augmented reality control signals to the device 70, which in turn interprets or otherwise processes those signals and presents the corresponding information to the driver. Other augmented reality platforms besides the HUD or HMD are possible, including but not limited to, contact lenses that display augmented reality imaging, a virtual retinal display, spatial augmented reality projectors, etc. According to one embodiment, the augmented reality device 70 is the same device as the wearable driver sensor 50; thus, the same component acts as both an input and output device for the system. A more thorough explanation of the use of the augmented reality device is provided below in the context of the present method.

Visual display unit 72, which is an optional component, can include any type of device that visually presents driving recommendations and/or other information to the driver. In one example, the visual display unit 72 is simply a graphical display unit (either a touch screen or non-touch screen) that is part of the vehicle instrument panel or controls, and it receives visual display control signals from control module 60. Like other visual displays, unit 72 processes the control signals and can then present the driver with the corresponding information, such as the current lap time, average lap speed, deviations from ideal or recommended acceleration and braking points, etc. In FIGS. 3 and 4, there are shown some non-limiting examples of potential visual display units 72 that are part of the vehicle instrumentation and are located next to traditional gauges like a speedometer or tachometer. Of course, the visual display unit 72 could be located on the center stack between the driver and front passenger seats or at some other suitable location, and the display unit could be adjusted or customized according to personal preferences. It may also be possible to have only one visual display unit 72, or multiple displays. Moreover, the visual display unit 72 may present information in real-time and be synchronized with the augmented reality device 70, or it could provide static, past or historical information in a way that complements the augmented display, to cite several possibilities.

The audible alert unit 74 and haptic alert unit 76 are also optional components within the performance driving system and can be used to further provide the driver with driving recommendations, alerts and/or other information. The audible alert unit 74 can be integrated within the vehicle's radio or infotainment system or it can be a standalone component. In one instance, the audible alert unit 74 receives audible alert control signals from control module 60 and, in response thereto, emits chimes, noises and/or other alerts to inform the driver of a driving recommendation, like a recommended acceleration or braking points as they relate to a curve or straightaway on the course. The haptic alert unit 76 can provide haptic or tactile feedback through interior components of the vehicle, such as the steering wheel or the driver seat. For example, the haptic alert unit 76 can be integrated within the driver's seat and can generate vibrations or other disturbances in response to haptic alert control signals from the control module 60 to inform the driver that he or she has missed a recommended acceleration or braking point or that the driver is deviating from a recommended path. A haptic response on the left side of the driver's seat could be used when the driver begins to edge outside the ideal path to the left, while a haptic response on the right side of the seat could indicate deviation on the right side of the ideal path. Other embodiments and implementations of these devices are certainly possible.

The on-board data recording unit 78 and the remote data recording unit 80, which are also optional, can gather and record various pieces of information and data during the performance driving event so that they can be evaluated and reviewed by the driver at a later time. Any of the parameters, readings, signals, inputs, outputs and/or other data or information discussed above may be recorded at the vehicle by the on-board data recording unit 78 or wirelessly sent to the remote data recording unit 80 via a telematics unit or the like so that the information can be housed remotely, such as in a cloud database. The on-board data recording unit 78 may be integrated within the control module 60 or some other suitable piece of hardware located on the vehicle, while the remote data recording device 80 could be part of a cloud database or data repository. It should be appreciated that myriad programs, applications and software could be used to analyze and evaluate the data at a later date and that such data could be shared via social media, websites or any other suitable platform where racing enthusiasts or other like minded drivers wish to share and discuss their performance driving experiences.

Telematics unit 82 enables wireless voice and/or data communication over a wireless carrier system so that the vehicle 10 can communicate with a backend facility, other telematics-enabled vehicles, or some other remotely located entity or device. Any suitable telematics unit 82 and wireless communication scheme may be employed and, in one embodiment, the telematics unit exchanges performance driving data with the remote data recording unit 80 located in the cloud, as described above. Any suitable wireless communication standard, such as LTE/4G or other standards designed to handle high speed data communication, could be employed.

The particular combination of vehicle sensors 20-36, exterior sensors 40-44, driver sensors 50-52, control module 60, and output devices 70-82 described above is simply provided as an example, as different combinations of such devices could be used, including those having devices not shown in FIG. 1.

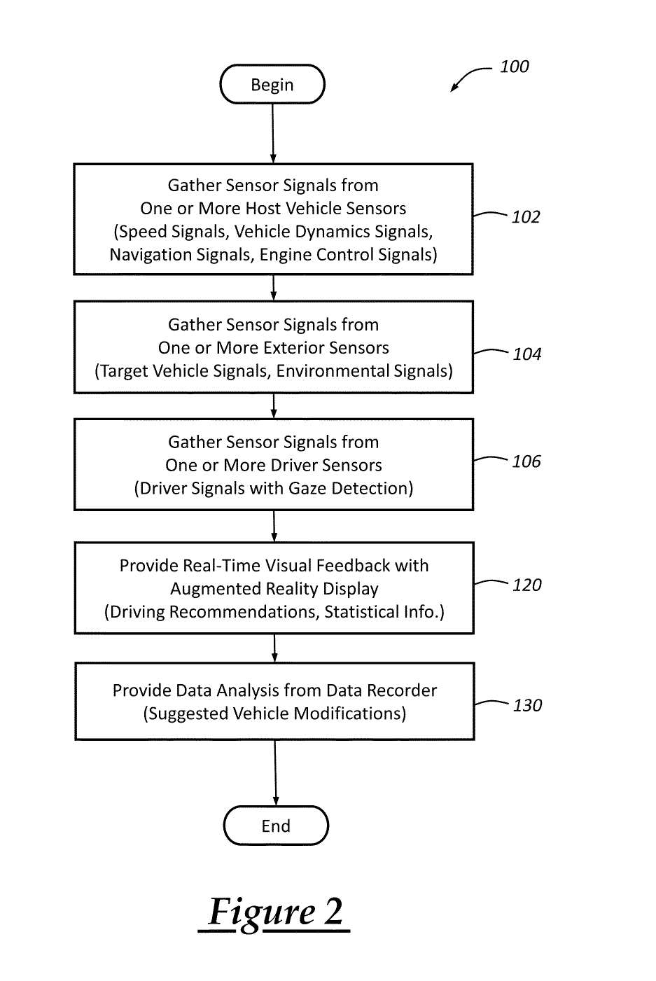

Turning now to the flowchart in FIG. 2, there is shown an exemplary method 100 for using a performance driving system, such as the one shown in FIG. 1. As mentioned above, the system 12 is a performance driving tool that is designed to gather information during performance driving events and to provide feedback to a driver so as to enhance the driving experience, such as real-time or on-track visual feedback provided by an augmented reality device. The feedback provided can be in the form of driving recommendations or coaching suggestions, as well as current and/or historical driving data and parameters relating to that particular driver, vehicle and/or track. The following description of method 100 assumes that the vehicle 10 is a track vehicle being driven on a known track or course and that the driver has enabled or otherwise engaged the performance driving system 12.

In step 102, the method receives sensor signals or readings from one or more vehicle sensors 20-36. The precise combination of sensor signals gathered can depend on a variety of factors, including how the driver has customized or set up the performance driving system 12. In one embodiment, step 102 gathers some combination of: speed signals indicating vehicle speed from speed sensors 20-26; vehicle dynamics signals from vehicle dynamics sensor unit 28 representing vehicle acceleration, yaw rate or other vehicle parameters; navigation signals from the navigation unit 30 informing the system of the current location of the vehicle 10; engine status signals from the engine control module 32 representing engine, transmission, or other drive train-related information; brake status signals from the brake control module 34 representing braking status, stability readings, or other braking-related information; steering status signals from the steering control module 36 providing information on steering angle or position or other steering-related information; and/or a VIN or other vehicle identifier that provides the system with various pieces of information relating to the vehicle, as described above. In this example, the various sensor signals are sent from components 20-36 to the control module 60 over a suitable vehicle communications network, like a central communications bus.

Step 104, which is an optional step, receives sensors signals or readings from one or more exterior sensors 40-44. As discussed above, a potential output of the performance driving system 12 pertains to recommended or ideal driving lines that are projected onto the vehicle windshield via a heads-up-display (HUD) or other augmented reality device. If the vehicle 10 is being driven on a track or course with other vehicles, the method may consider the presence of other target vehicles before recommending driving lines to the driver. In such a scenario, step 104 gathers target vehicle signals from the target vehicle sensors 40-42, where the signals provide information about one or more surrounding vehicles, stationary objects like guardrails or debris in the road, or a combination thereof. This information may then be used by the method to alter or adjust the recommended driving lines to take such objects into account. In another example, step 104 may gather environmental signals from environmental sensor 44 that provides information as to weather and other conditions outside of the vehicle 10. If it is extremely hot or cold outside, or if it is extremely wet or dry, or if there are conditions suggesting ice or other slippery road surfaces—these are all conditions that the method may take into account before making driving recommendations, as explained below.

Turning now to step 106, the method receives signals or readings from one or more driver sensors 50-52 that monitor different aspects of the driver's human behavior. As mentioned above, driver sensors 50-52 can include cameras that are trained or focused on the driver's eyes, face or other body parts so that information regarding his or her behavior, actions, intentions, etc. can be gathered and potentially used by the method to better make driving recommendations in real-time, as will be explained. In a sense, this combination of both statistical vehicle-related input from sensors 20-36, as well as human- or driver-related input from sensors 50-52, helps method 100 develop a richer and more complete picture of the performance driving event that is occurring so that better driving recommendations can be made. Some more specific examples of how this information is used are provided in the following paragraphs and in conjunction with FIGS. 2 and 3. In one particular embodiment of step 106, sensor 50 is in the form of either a vehicle mounted camera located within the cabin near the driver or a head-mounted-display (HMD) device like Google Glass™, and the sensor provides control module 60 with driver signals that include gaze detection information; that is, information regarding the direction, orientation, size, etc. of different parts of the driver's eyes, as well as the duration of the stare or gaze. Step 106 may optionally gather additional information from driver sensor 52 in the form of driver signals that indicate other behavioral characteristics, such as driver hand position on the steering wheel, driver posture, facial expressions, etc.

It should be appreciated that the various sensor signals and readings gathered in steps 102-106 could be obtained in any number of different ways. For instance, the sensor signals could be provided on a periodic or aperiodic basis by the various sensor devices, they could be provide without being requested by the control module or in response to a specific request, they could be packaged or bundled with other information according to known techniques, etc. The precise manner in which the sensor signals are electronically gathered, packaged, transmitted, received, etc. is not important, as any suitable format or protocol may be used. Also, the particular order of steps 102-106 is not necessary, as these steps could be performed in a different order, concurrently, or according to some other sequence.

Once the various inputs have been gathered, the method proceeds to step 120 so that the performance driving system 12 can process the information and provide the driver with one or more driving recommendations. The following examples of potential driving recommendations are not intended to be in any order, nor are they intended to be confined to any particular combination, as the driver may customize which recommendations are provided and how.

Starting with step 120, which is described in conjunction with the heads-up-display (HUD) and the augmented reality display 88 of FIG. 3, the method provides real-time or on-track visual feedback through the augmented reality device 70, which can project both driving recommendations and statistical information onto the vehicle windshield 90. Driving recommendations generally include display elements that pertain to the particular track or course being driven, such as predicted driving lines 200, recommended driving lines 202, and ideal driving lines (not shown). In a sense, all of the preceding driving lines are virtual in that they are not actually painted or marked on the road surface, but instead are generated by the system 12. In FIG. 3, the predicted driving line 200 is the extrapolated or anticipated driving path for the vehicle 10; put differently, if the vehicle were to stay on its present course under the present conditions, it would likely follow the predicted driving line 200. Thus, system 12 uses one or more of the various inputs gathered in step 102 to generate the predicted driving line 200, and then projects the predicted line onto the vehicle windshield 90 so that the driver can easily see the current path that they are on. In the embodiment where the output device is a head-mounted-display (HMD), the system could provide an augmented reality display 92 that includes one or more virtual driving line(s) onto a viewing lens or window of the HMD so the driver can see their anticipated path or recommended paths overlaid or superimposed on top of the actual road surface.

The recommended driving line 202, on the other hand, represents the ideal or optimum driving line or path based on the current driving scenario, such as vehicle location, vehicle speed, vehicle acceleration, yaw rate, current gear selection, braking status, vehicle stability, steering angle, and/or environmental or weather conditions, to cite a few. For instance, the method may consider vehicle acceleration and generate one recommended driving line for when the vehicle is accelerating into a turn and another recommended driving line for when the vehicle is decelerating into the same turn. In a different example, the method could take into account whether the transmission recently was downshifted into a certain gear before prescribing a recommended driving line. If the method sensed certain exterior weather conditions, such as rain, sleet, snow, ice, etc. on the road surface, then this too could be taken into account by the method when providing the recommended driving line. Of course, other factors may also be considered. In the exemplary illustration in FIG. 3, the recommended driving line 202 is projected on windshield 90 and is located on the inside of the predicted driving line 200, thereby indicating that the driver is somewhat understeering the vehicle in this particular turn.

In another embodiment, step 120 generates an ideal driving line (not shown), where the ideal driving line represents a theoretically ideal or optimum driving line independent of the current driving scenario. For instance, the ideal driving line could represent the theoretically perfect path or route to take for that particular vehicle on that particular track based on computer simulations, or the ideal driving line could represent the driver's previous personal best lap for that particular track and could be retrieved, for example, from the on-board or remote data recording unit 78, 80. In a different example, the ideal driving line represents the best or fastest lap of a different driver; such as if a group of friends were all racing similar track vehicles on the same track and wanted to compare the best laps of one another. In each of the preceding embodiments, the ideal driving line may be projected or displayed with the augmented reality device 70 (e.g., a heads-up-display (HUD) or a head-mounted-display (HMD)) so that the driver feels as though he or she is racing against a “ghost driver” and is hopefully able to improve the lap times. The ideal driving line may or may not take other factors into account, like environmental factors, or it could be based on some other suitable benchmark. The performance driving system 12 could help to distinguish the different driving lines from one another by using different colors or patterns; for example, black for the predicted driving line 200, blue for the recommended driving line 202, green for the ideal driving line, etc. Of course, other indicia and techniques (e.g., adjusting the pattern, gradient, transparency, brightness, contrast, shading, weight, etc. of the lines) could be used to intuitively distinguish one line from another.

Another potential feature of the performance driving system 12 involves a comparison of one or more of the virtual driving lines mentioned above. Step 120 may compare the predicted driving line 200 of the vehicle to the recommended driving line 202, and then provide an alert or indication to the driver based on that comparison. For example, if the predicted driving line 200 and the recommended driving line 202 deviate by more than some predetermined amount (i.e., the lateral distance between these two lines exceeded some threshold), then the performance driving system 12 could send an alert to the driver in one of a number of different ways. The alert could be in the form of a textual message, one or both of the driving lines could change colors (e.g., they could turn red), a border or perimeter around the display could flash, or any other suitable technique to notify the driver that these driving lines had deviated by more than a recommended amount. This type of alert or information could be conveyed to the driver via the augmented reality device 70, the visual display unit 72, the audible alert unit 74, the haptic alert unit 76 or some combination thereof. Of course, the aforementioned alerts could also be used to address deviations between the other driving lines, such as between the predicted driving line 200 and the ideal driving line (not shown) or between the recommended driving line 202 and the ideal driving line, just as well. If the driver follows the recommended driving line, it is possible for the predicted and recommended driving lines 200 and 202 to overlap or merge with one another on the display being projected on the windshield 90. This scenario too could be conveyed to the driver via one or more of the alerts listed above.

The performance driving system 12 may also use driver signals from the driver sensors 50, 52 to make adjustments to one or more of the driving lines mentioned above. According to one embodiment, step 120 may use the gaze detection features of driver sensors 50, 52 (e.g., when the driver is wearing a head-mounted-display (HMD) device) to dynamically adjust the course or path of one or more of the virtual driving lines in order to take into account the driver's intentions. In FIG. 3, the original predicted driving line 200 is shown, as well as a gaze-modified predicted driving line 200′, which is slightly shifted to the right to reflect the direction of the driver's gaze, which is in the direction of the inside of the turn. Similar gaze-modification techniques may be used to adjust the other driving lines and generate gaze-modified recommended driving lines 202′ and gaze-modified ideal driving lines (not shown). In this way, the system and method are able to dynamically alter or adjust the on-track visual feedback being provided to the driver in real-time based on where they are looking. One possible way to implement this feature is to quantify the relative amount of driver eye movement from some reference point, and then translate the amount of eye movement to a corresponding amount of movement of the projected driving line on the road surface (e.g., a certain degree of eye movement results in a corresponding displacement of the driving line on the display, and can be impacted by factors such as the image plane of the augmented reality display). Other techniques can certainly be used to correlate the gaze detection information to the various driving recommendations provided by the method.

Another use of driver signals from driver sensors 50, 52 involves the phenomenon of parallax. The alignment of display elements in the augmented reality scene projected on the windshield 90 may appear in different locations depending on the driver's gaze. This phenomenon is known as parallax. In order for a driver to process spatial distance from his or her body to a target object, the user must take into account dynamic variables computed by the brain via multiple gradients of input flow in space and time. The parallax phenomenon can occur when the visual system of the brain tries to infer the three-dimensional structure of the world from a two-dimensional retinal image. Movement of the head can cause an apparent movement of near objects with respect to distant ones. The closer the object is to the user, the bigger the apparent movement may become. In other words, parallax allows the brain to infer the three-dimensional structure of the world based on the fact that objects closer to the user will move faster than objects further away as the user travels through the environment. Accordingly, parallax can affect the augmented reality scene provided by device 70 because when a user moves his or her head, display elements may move faster than environmental ones. The present method is able to account for movements of the driver's head, such as those affecting the driver's gaze, to shift the driving lines back to where they should be, instead of the lines being where the user perceives them due to the parallax phenomenon.

In the preceding embodiments, the method has provided driving recommendations in the form of virtual driving lines, however, other types of recommendations or suggestions may be presented to the driver as well. For instance, step 120 may provide the driver with one or more driving recommendations in the form of braking, accelerating, steering and/or shifting recommendations. The augmented reality device 70 may use color, patterns or other indicia to inform the driver of when and the extent to which they should brake, accelerate, steer and/or shift. To illustrate, if the method determines that the driver should begin a braking event, a braking indicator in the form of one or more of the driving lines changing colors (e.g., turning red) and a linear gradient grid may be used to indicate the amount of brake force to be used. Full red could indicate that the user should apply full force to the brakes, while reddish-yellow could indicate that the user should gradually apply the brakes, to cite one example. A similar approach could be taken with acceleration recommendations. For example, full green could indicate that the driver should apply full force to the throttle, while yellowish-green could indicate that the driver should accelerate gradually. These and other braking and accelerating indicators may be employed by the performance driving system 12.

According to different embodiments, various types of steering indicators may be used to make steering recommendations. For example, the output devices could include haptic elements that are integrated into different parts of the driver seat, steering wheel, other vehicle parts, etc. and are used to alert or convey different driving recommendations. If the predicted path of the vehicle is too far left of a recommended or ideal path, or if the method is indicating that the driver should begin a left-turn steering sequence, then haptic elements on the left side of the driver's seat may be used to alert the driver of these recommendations with vibrations through the left side of the seat. Other steering indicators could include recommendations that are projected onto the vehicle windshield via the heads-up-display (HUD) and inform the driver of potential over-steering and under-steering. In one particular example, the augmented reality device 70 could display a point of reference on the vehicle windshield 90 and could instruct the driver to steer until reaching the chosen point and then realign the vehicle. Accordingly, a steering indicator may be used by the system to convey steering recommendations or suggestion, and a visual steering indicator could be accompanied with corresponding audible, haptic and/or other alerts.

The method may also monitor when the driver shifts gears in a manual transmission and use the augmented reality device 70 and/or some other output device to suggest ideal shifting points with one or more shifting indicators. In the example of a visual shifting indicator, the heads-up-display (HUD) could present a visual or graphical alert that inform the driver when they have shifted too early, too late or at the optimal time. It should be appreciated that the different driving recommendations or on-track coaching tips described above are not limited to any particular combination of output devices, as those recommendations or indicators could be carried out with any combination of visual, audible and/or haptic output devices. It is also possible for the present method to assist with stabilizing the vehicle if the performance driving system 12 detects that the vehicle is losing control or is otherwise becoming instable.

It is also possible for the method to provide the driver with suggestions in terms of vehicle modifications, and these suggestions or recommendations can be provided in real-time or at some later stage. An example of a suggested vehicle modification is recommending a change in the air pressure in one or more of the tires to make the tires more suitable for the particular course being driven. Again, this recommendation could be made in real-time via the augmented reality device 70 so that the driver may increase or decrease the tire pressure at some time during the course, or it could be made after the driving is finished, such as during step 130.

As mentioned above, the method may present the driver with both driving recommendations and statistical information, and may do so with the augmented reality device 70 and/or some other output device. With reference to FIGS. 3 and 4, the augmented reality display in each of these figures includes both driving recommendations and statistical information. The statistical information may change or be updated in real-time in an augmented reality scene, but it is less in the form of recommendations and more in the form of statistics that may be useful to the driver. Statistical information may include a course map 222, average and target performance parameters 224 (e.g., the average vehicle speed so far next to the target vehicle speed for that course), a gear indicator 226, and a target lap time indicator 228. Other statistical information and display elements are possible. It should also be noted that it may be possible to overlay display elements over each other, for example, where a static display element such as the course map is superimposed on top of the display elements.

Once the method has provided real-time or on-track feedback to the driver and the vehicle is no longer being driven on the track or course, step 130 may provide data analysis or some other type of summary from all of the information and data that was collected during the drive. This data may come from an on-board data recording unit 78, a remote data recording unit 80, or some combination thereof. The type of analysis that is performed is largely dictated by how the user has set up the performance driving system 12, as the system has many settings and options and may be customized in myriad ways. In one example, step 130 evaluates the various lap times, driving line actually taken by the vehicle 10, acceleration and/or deceleration points, etc. and then provides the user with a summary of the race; this summary may or may not include driving recommendations, coaching tips, etc. It is also possible for information and data to be shared through various social media platforms or networking sites.

Again, the preceding description of the exemplary performance driving system 12 and the drawings in FIGS. 1-4 are only intended to illustrate potential embodiments, as the following method is not confined to use with only that performance driving system. Any number of different systems, modules, devices, etc., including those that differ significantly from the ones shown in FIGS. 1-4, may be used instead.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A performance driving system for a vehicle, comprising:
one or more vehicle sensor(s), the vehicle sensor(s) include a navigation unit that provides navigation signals representative of vehicle location;
one or more output device(s), the output device(s) include an augmented reality device that provides real-time visual feedback to a driver; and
a control module coupled to the vehicle sensor(s) and the output device(s), wherein the control module is configured to provide control signals to the augmented reality device that are at least partially based on the vehicle location and that cause the augmented reality device to provide the driver with real-time visual feedback that includes one or more virtual driving line(s) superimposed on top of an actual road surface seen by the driver.

2. The performance driving system of claim 1, wherein the vehicle sensor(s) further include: a speed sensor that provides speed signals representative of vehicle speed, a vehicle dynamics sensor unit that provides vehicle dynamics signals representative of vehicle acceleration, an engine control module that provides engine status signals representative of an engine or transmission state, a brake control module that provides brake status signals representative of a braking state, and a steering control module that provides steering status signals representative of a steering angle; and
the control module is further configured to provide control signals to the augmented reality device that are at least partially based on one or more parameters selected from the group consisting of: the vehicle speed, the vehicle acceleration, the engine or transmission state, the braking state, or the steering angle.

3. The performance driving system of claim 1, further comprising:
one or more exterior sensor(s), the exterior sensor(s) include a target vehicle sensor that provides target vehicle signals representative of one or more nearby object(s); and
the control module is coupled to the exterior sensor(s) and is further configured to provide control signals to the augmented reality device that are at least partially based on the presence of the nearby object(s).

4. The performance driving system of claim 1, further comprising:
one or more exterior sensor(s), the exterior sensor(s) include an environmental sensor that provides environmental signals representative of the outside weather or other conditions exterior to the vehicle; and
the control module is coupled to the exterior sensor(s) and is further configured to provide control signals to the augmented reality device that are at least partially based on the outside weather or other conditions exterior to the vehicle.

5. The performance driving system of claim 1, further comprising:
one or more driver sensor(s), the driver sensor(s) include a camera that is directed towards the face of the driver and provides driver signals representative of facial behavior; and
the control module is coupled to the driver sensor(s) and is further configured to provide control signals to the augmented reality device that are at least partially based on the facial behavior of the driver.

6. The performance driving system of claim 5, wherein the camera is part of a head-mounted-display (HMD) that is worn by the driver and provides driver signals representative of facial behavior that include gaze detection information; and
the control module is further configured to provide control signals to the augmented reality device that cause the augmented reality device to adjust the virtual driving line(s) at least partially based on the gaze of the driver.

7. The performance driving system of claim 1, wherein the augmented reality device further includes a heads-up-display (HUD); and
the control module is further configured to provide control signals to the HUD that cause the HUD to project the real-time visual feedback on a windshield of the vehicle so that the virtual driving line(s) are projected images superimposed on top of the actual road surface seen by the driver.

8. The performance driving system of claim 1, wherein the augmented reality device further includes a head-mounted-display (HMD) that is worn by the driver; and
the control module is further configured to provide control signals to the HMD that cause the HMD to display the real-time visual feedback on a viewing lens of the HMD so that the virtual driving line(s) are displayed images superimposed on top of the actual road surface seen by the driver.

9. The performance driving system of claim 1, wherein the virtual driving line(s) include at least one driving line selected from the group consisting of: a predicted driving line representative of an anticipated path of the vehicle, a recommended driving line representative of a suggested path of the vehicle based on current conditions, or an ideal driving line representative of an ideal path for the vehicle.

10. The performance driving system of claim 1, wherein the virtual driving line(s) include a predicted driving line representative of an anticipated path of the vehicle and at least one other driving line; and
the control module is further configured to compare the predicted driving line and the at least one other driving line and to provide control signals to the augmented reality device that cause the augmented reality device to alert the driver when the driving lines deviate by a certain amount.

11. The performance driving system of claim 1, wherein the control module is further configured to provide control signals to the augmented reality device that cause the augmented reality device to make one or more driving recommendation(s) to the driver, and the driving recommendation(s) is selected from the group consisting of: a braking recommendation, an acceleration recommendation, a steering recommendation, or a shifting recommendation.

12. The performance driving system of claim 1, wherein the output device(s) further include a haptic alert unit integrated within a driver seat; and
the control module is further configured to provide control signals to the haptic alert unit that cause the haptic alert unit to inform the driver of a driving recommendation by issuing vibrations through the driver seat.

13. The performance driving system of claim 1, wherein the output device(s) further include a data recording unit located in the vehicle, away from the vehicle, or both; and
the control module is further configured to instruct the data recording unit to record information and data during a driving event on the known course so that information and data can be subsequently evaluated or shared.

14. The performance driving system of claim 13, wherein the data recording unit is located away from the vehicle and is part of a cloud-based data storage system; and
the control module is further configured to instruct a telematics unit to wirelessly send information and data gathered during a driving event on the known course to the remote data recording unit so that information and data can be subsequently evaluated or shared.

15. A performance driving system for a vehicle, comprising:
one or more driver sensor(s), the driver sensor(s) include a camera that is directed towards the face of the driver and provides driver signals representative of the facial behavior of the driver;
one or more output device(s), the output device(s) provide on-track driving recommendations to a driver; and
a control module coupled to the driver sensor(s) and the output device(s), wherein the control module is configured to provide control signals to the output device(s) that cause the output device(s) to make adjustments to the on-track driving recommendations based at least partially on changes in the facial behavior of the driver.

16. A method for operating a performance driving system for a vehicle, comprising the steps of:
receiving signals from one or more vehicle sensor(s) at a control module while the vehicle is being driven, the vehicle sensor signals relate to the operational state of the vehicle;
receiving signals from one or more driver sensor(s) at the control module while the vehicle is being driven, the driver sensor signals relate to the facial behavior of the driver;
providing the driver with one or more driving recommendation(s) while the vehicle is being driven, wherein the driving recommendation(s) is at least partially based on the vehicle sensor signals; and
adjusting the driving recommendation(s) while the vehicle is being driven, wherein the adjustment to the driving recommendation(s) is at least partially based on the facial behavior of the driver.

17. The method of claim 16, wherein the second receiving step further includes receiving driver sensor signals with gaze detection information from a camera that is part of a head-mounted-display (HMD) unit being worn by the driver; and
the adjusting step further includes adjusting the driving recommendation(s) based at least partially on the gaze detection information.

18. The method of claim 16, wherein the providing step further includes providing the driver with the driving recommendation(s) by projecting real-time visual feedback onto a windshield of the vehicle with a heads-up-display (HUD), and the real-time visual feedback includes one or more virtual driving line(s) superimposed on top of a road surface seen by the driver.

19. The method of claim 18, wherein the one or more virtual driving line(s) includes at least one driving line selected from the group consisting of: a predicted driving line representative of an anticipated path of the vehicle, a recommended driving line representative of a suggested path for the vehicle based on current conditions, or an ideal driving line representative of an ideal path for the vehicle.

20. The method of claim 18, wherein the one or more virtual driving line(s) include a predicted driving line representative of an anticipated path of the vehicle and a recommended driving line representative of a suggested path of the vehicle based on current conditions, and the predicted and recommended driving lines are projected onto the windshield at the same time so that the driver is visually presented with an indication as to how much the anticipated and suggested paths of the vehicle deviate.

21. The method of claim 18, wherein the one or more virtual driving line(s) includes a gaze-modified driving line that is at least partially based on an original driving line and the facial behavior of the driver, and the gaze-modified driving line is adjusted from the original driving line in the direction that the driver is gazing.

22. The method of claim 16, wherein the providing step further includes providing the driver with one or more driving recommendation(s) selected from the group consisting of: a braking recommendation, an acceleration recommendation, a steering recommendation, or a shifting recommendation.
